(19) United States
(12) Patent Application Publication
(10) Pub. No.: US 2016/0084124 A1
(43) Pub. Date: Mar. 24, 2016

(54) Hybrid Oil Pump System and Method of Controlling the Same

(71) Applicant: Hyundai Motor Company, Seoul (KR)

(72) Inventor: Young Rock CHUNG, Yongin-Si (KR)

(73) Assignee: Hyundai Motor Company, Seoul (KR)

(21) Appl. No.: 14/554,408

(22) Filed: Nov. 26, 2014

(30) Foreign Application Priority Data
Sep. 19, 2014 (KR) 10-2014-0124768

(51) Int. Cl. F01M 1/02; F16D 21/00; F16D 41/00

(52) U.S. Cl. CPC F01M 1/02; F16D 41/00; F16D 21/00; F01M 2001/0253; F01M 2001/0246; F16D 2500/10418; F16D 2500/10493

(57) ABSTRACT

A hybrid oil pump system may include a motor connected to an oil pump and supplying torque, an engine disposed to supply torque to the oil pump, and a first one-way clutch disposed in a line through which the torque from the engine may be supplied to the oil pump, and selectively supplying the torque from the engine to the oil pump in accordance with a difference in RPM between the engine and the motor.

### CROSS REFERENCE TO RELATED APPLICATION

The present application claims priority of Korean Patent Application Number 10-2014-0124768 filed on Sep. 19, 2014, the entire contents of which application are incorporated herein for all purposes by this reference.

### BACKGROUND OF THE INVENTION

1. Field of the Invention

The present invention, in general, relates to a hybrid oil pump system, and, more particularly, to a hybrid oil pump system that improves fuel efficiency by using an electric oil pump for an operation period not requiring a mechanical oil pump and that improves durability by minimizing mechanical friction of an engine, and a method of controlling the hybrid oil pump system.

2. Description of Related Art

Vehicles are equipped with various hydraulic devices operated by hydraulic pressure such as an automatic transmission and the hydraulic devices are usually supplied with hydraulic pressure by a mechanical oil pump directly connected to the crankshaft of an engine.

Vehicles that need to run with the engine stopped, such as a hybrid vehicle, are equipped with an electric oil pump separately from a mechanical oil pump. That is, when a mechanical oil pump stops with an engine stopped, hydraulic pressure keeps supplied by an electric oil pump.

Such a mechanical oil pump is operated by power from an engine, so it is disadvantageous in terms of fuel efficiency. Accordingly, technologies for replacing a mechanical oil pump with an electric oil pump have been proposed in recent years.

However, the torque for supplying hydraulic pressure when a vehicle is being driven is too large for an oil pump only driven by electricity, so a motor having very large capacity is required, and it is disadvantageous in layout accompanying installation and design of the motor and in manufacturing cost.

Further, when a vehicle is driven under extreme conditions, the motor consumes power too much.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a hybrid oil pump system that improves fuel efficiency by using an electric oil pump for an operation period not requiring a mechanical oil pump and that improves durability by minimizing mechanical friction of an engine, and a method of controlling the hybrid oil pump system.

In an aspect of the present invention, there is provided a hybrid oil pump system including: a motor connected to an oil pump and supplying torque; an engine disposed to supply torque to the oil pump; and a first one-way clutch disposed in a line through which the torque from the engine is supplied to the oil pump, and selectively supplying the torque from the engine to the oil pump in accordance with a difference in RPM between the engine and the motor.

The system may further include an engine driveshaft rotated by the torque from the engine, in which the first one-way clutch may be connected to an end of the engine driveshaft.

The first one-way clutch may be engaged when an engine RPM is larger than a motor RPM, and may be disengaged when the engine RPM is smaller than the motor RPM.

The system may further include a controller operating the oil pump with the torque from the motor or the torque from the engine by engaging or disengaging the first one-way clutch in accordance with the difference in RPM between the engine and the motor by adjusting the motor RPM in accordance with an engine output value or a fluid temperature.

The first one-way clutch may be disposed between the motor and the engine.

The motor, the first one-way clutch, and the engine may be arranged in series from an end of the oil pump.

The first one-way clutch may be disposed between the oil pump and the engine.

The motor may be connected to a first end of the oil pump, and the first one-way clutch and the engine may be connected to a second end of the oil pump.

The motor may be connected directly to the oil pump.

The system may further include a second one-way clutch disposed between the motor and the oil pump and connecting/disconnecting the motor and the oil pump to/from each other in accordance with the difference in RPM between the motor and the oil pump.

The second one-way clutch may be engaged when a motor RPM is larger than an engine RPM, and may be disengaged when the motor RPM is smaller than the engine RPM.

The second one-way clutch, the motor, the first one-way clutch, and the engine are arranged in series from an end of the oil pump.

The second one-way clutch and the motor may be connected to a first end of the oil pump, and the first one-way clutch and the engine may be connected to a second end of the oil pump.

The system may further include a motor driveshaft rotated by the torque from the motor, in which the motor driveshaft and the engine driveshaft may be arranged on the same axis.

The oil pump may be a variable oil pump changing a flow rate of oil in accordance with an engine output value and a fluid temperature that indicate a driving state of a vehicle.

According to another aspect of the present invention, there is provided a method of controlling the hybrid oil pump system which includes: measuring an engine output value and a fluid temperature that indicate a driving state of a vehicle; and controlling the oil pump to be operated by torque from the motor or torque from the engine by engaging or disengaging the first one-way clutch in accordance with a difference in RPM between the engine and the motor by adjusting a motor RPM in accordance with the engine output value and the fluid temperature.

The engine output value may be an engine RPM or an engine load and the fluid temperature may be an oil temperature or a cooling water temperature.

The controlling may include: engine operation controlling that obtains a measurement value on the basis of the engine output value and the fluid temperature and adjusts a motor RPM to be less than an engine RPM so that the first one-way clutch is engaged and the oil pump is operated by the torque from the engine, when the measurement value is included in an engine operation standard value in a driving map showing a relationship between the engine output value and the fluid temperature; and motor operation controlling that adjusts the motor RPM over the engine RPM so that the first one-way clutch is disengaged and the oil pump is operated by the torque from the motor, when the measurement value is included in a motor operation standard value in the driving map.

In the motor operation controlling, oil pressure generated by the oil pump may be measured and the motor RPM may be adjusted so that the measured oil pressure follows a desired value.

The oil pump may be a variable pump and, in the engine operation controlling and the motor operation controlling, the oil pump may be controlled to change a flow rate of oil determined by the oil pump in accordance with an engine output value and a fluid temperature that indicate a driving state of a vehicle.

In the engine operation controlling, when conditions under which energy can be recovered are satisfied, power may be generated by the motor.

A second one-way clutch is further disposed between the motor and the oil pump in the system, the second one-way clutch may be disengaged and the torque from the engine may be transmitted to the motor by adjusting the motor RPM to be less than the engine RPM, in the engine operation controlling, and the second one-way clutch may be engaged and the oil pump may be operated by the torque from the motor by controlling the motor RPM over the engine RPM, in the motor operation controlling.

According to the present invention, since the oil pump can be operated by the torque from the motor and the torque from the engine is selectively transmitted to the oil pump by the first one-way clutch, the oil pump is controlled to be operated by the torque from the engine only for an operation period requiring high torque from the engine, for example, at a high speed, under a large load, and a low temperature while a vehicle runs. Accordingly, it is possible to improve fuel efficiency by minimizing the power consumed by the engine for operating the oil pump and it is also possible to reduce the manufacturing cost and the weight by designing the capacity of the motor as small as possible.

Further, since the oil pump is operated by the motor only for an actual operation period, it is possible to reduce a mechanical friction loss in mechanical oil pumps of the related art and it is also possible to recover energy by generating power through the motor when a vehicle coasts.

Further, it is possible to operate the oil pump in accordance with an engine requested hydraulic pressure by controlling duty of the motor and the capacity of a variable oil pump, so it is possible to minimize the power consumed by the motor.

Further, since the one-way clutches are used for connecting/disconnecting power, it is possible to reduce the entire size and the manufacturing cost of the system.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating the configuration of various exemplary embodiments of a hybrid oil pump system according to an exemplary embodiment of the present invention.

FIG. 2 is a diagram illustrating the configuration of various exemplary embodiments of a hybrid oil pump system according to an exemplary embodiment of the present invention.

FIG. 3 is a diagram illustrating the configuration of various exemplary embodiments of a hybrid oil pump system according to an exemplary embodiment of the present invention.

FIG. 4 is a diagram illustrating the configuration of various exemplary embodiments of a hybrid oil pump system according to an exemplary embodiment of the present invention.

FIG. 5 is a diagram illustrating a process flow of operating the hybrid oil pump systems shown in FIG. 1 and FIG. 2.

FIG. 6 is a diagram illustrating a process flow of operating the hybrid oil pump systems shown in FIG. 3 and FIG. 4.

FIG. 7 is a diagram illustrating a configuration of controlling an RPM of a motor, in consideration of engine output value and fluid temperature in a hybrid oil pump system according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Embodiments of the present invention will be described hereafter in detail with reference to the accompanying drawings.

A hybrid oil pump system of the present invention largely includes a motor 10, an engine 20, and a first one-way clutch 30.

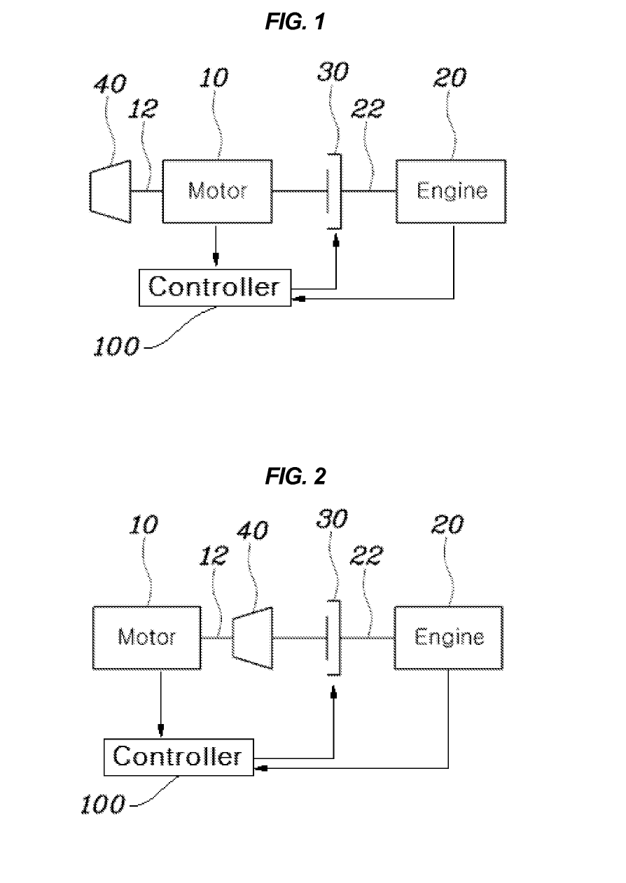

Describing the present invention in detail with reference to FIGS. 1 and 2, the motor 10, which may be a motor having the function of a generator, is connected to an oil pump 40 and supplies torque to the oil pump 40.

The engine 20 is disposed to supply torque to the oil pump 40 and an engine driveshaft 22 may be connected to the engine 20 through an engine drive pulley or gears.

The first one-way clutch 30 is disposed on the line through which the torque from the engine 20 is transmitted to the oil pump 40 and makes the torque from the engine be selectively supplied to the oil pump 40, depending on the difference in RPM between the engine 20 and the motor 10.

The first one-way clutch 30 may be connected to an end of the engine driveshaft 22.

In particular, the first one-way clutch 30 may have a structure that is engaged when the engine RPM is larger than the motor RPM and that is disengaged when the engine RPM is smaller than the motor RPM.

That is, an inner race and an outer race of the first one-way clutch 30 are connected to the engine 20 and the motor 10, respectively, and one of the inner race and the outer race which transmits power when its rotational speed is larger should be connected to the engine driveshaft 22.

According to this configuration, since the oil pump 40 can be operated by the torque from the motor 10 and the torque from the engine 20 is selectively transmitted to the oil pump 40 by the first one-way clutch 30, the oil pump 40 is operated by the torque from the engine 20 only for an operation period requiring large torque from the engine 20, such as at a high speed, under a large load, and at a low temperature while a vehicle runs.

Accordingly, the power consumption by the engine 20 for operating the oil pump 40 is minimized, thereby improving fuel efficiency, and the capacity of the motor 10 is designed as small as possible, thereby reducing the manufacturing cost and the weight.

The system may further include a controller 100 that controls the RPM of the motor 10 in accordance with engine output value and fluid temperature so that the oil pump 40 is operated by the torque from the motor 10 or the torque from the engine 20 by engaging or disengaging the first one-way clutch 30, depending on the difference in RPM between the engine 20 and the motor 10.

That is, the first one-way clutch 30 is engaged by adjusting the motor RPM to be smaller than the engine RPM for an operation period requiring large torque from the engine 20, such as at a high speed, under a large load, and at a low temperature while a vehicle runs, such that the torque from the engine 20 is supplied to the oil pump 40 and the oil pump 40 is operated by the torque from the engine 20.

On the contrary, the first one-way clutch 30 is disengaged by adjusting the motor RPM to be larger than the engine RPM for an operation period not requiring the torque from the engine 20, such as at a low speed, under a small load, and at a high temperature, such that the oil pump 40 is operated by the torque from the motor 10.

According to an exemplary embodiment of the present invention, as shown in FIGS. 1 and 2, the motor 10 and the oil pump 40 may be connected directly to each other. That is, fuel efficiency is improved by operating the oil pump 40 with the motor 10 in an actual operation period when a vehicle consumes a small amount of power.

Referring to FIG. 1 showing the structure of the first embodiment of the hybrid oil pump system of the present invention, the first one-way clutch 30 may be disposed between the motor 10 and the engine 20.

For example, the motor 10, the power transmission device 30, and the engine 20 may be arranged in series from an end of the oil pump 40.

Referring to FIG. 2 showing the structure of the second embodiment of the hybrid oil pump system of the present invention, the first one-way clutch 30 may be disposed between the oil pump 40 and the engine 20.

For example, the motor 10 may be connected to a first end of the oil pump 40 and the first one-way clutch 30 and the engine 20 may be connected to a second end of the oil pump 40. That is, the motor 10, and the first one-way clutch 30 and the engine 20 may be arranged in parallel with the oil pump 40 therebetween.

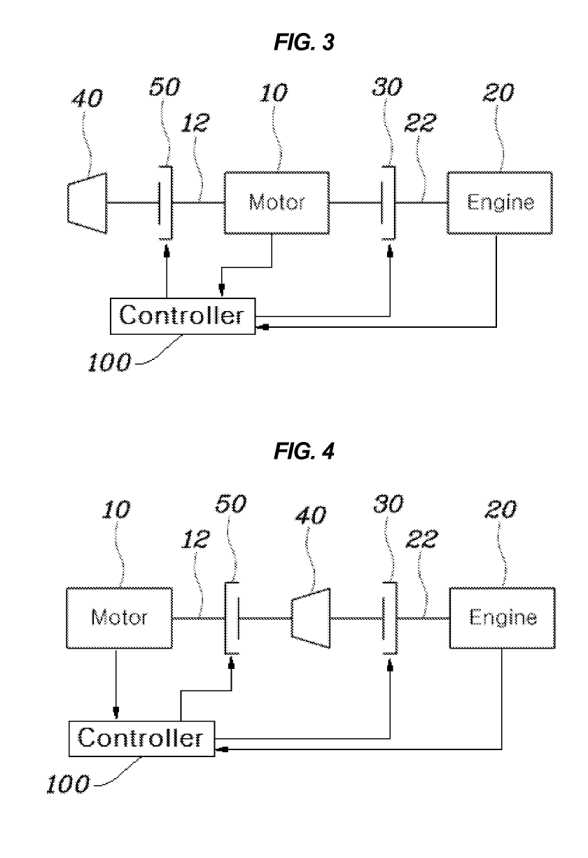

According to an exemplary embodiment of the present invention, as shown in FIGS. 3 and 4, torque supply from the engine 20 to the motor 10 can be mechanically controlled by a second one-way clutch 50.

For example, the second one-way clutch 50 may be disposed between the motor 10 and the oil pump 40 to connect/disconnect the motor 10 and the oil pump 40 to/from each other, depending on the difference in RPM between the motor 10 and the oil pump 40.

In detail, the second one-way clutch 50 may have a structure that is engaged when the motor RPM is larger than the engine RPM and that is disengaged when the motor RPM is smaller than the engine RPM. A first end of a motor driveshaft 12 rotated by the torque from the motor 10 is coupled to an end of the motor 10 and the second one-way clutch 50 is coupled to a second end of the motor driveshaft 12.

That is, an inner race and an outer race of the second one-way clutch 50 are connected to the motor 10 and the oil pump 40, respectively, and one of the inner race and the outer race which transmits power when its rotational speed is larger should be connected to the motor driveshaft 12.

Referring to FIG. 3 showing the structure of the third embodiment of the hybrid oil pump system of the present invention, the second one-way clutch 50, the motor 10, the first one-way clutch 30, and the engine 20 may be arranged in series from an end of the oil pump 40.

Referring to FIG. 4 showing the structure of the fourth embodiment of the hybrid oil pump system of the present invention, the second one-way clutch 50 and the motor 10 may be connected to a first end of the oil pump 40 and the first one-way clutch 30 and the engine 20 may be connected to a second end of the oil pump 40. That is, the second one-way clutch and the motor 10, and the first one-way clutch 30 and the engine 20 may be arranged in parallel with the oil pump 40 therebetween.

The present invention may include a pump shaft transmitting torque to the oil pump 40, and the engine driveshaft 22, the motor driveshaft 12, and the pump shaft may be arranged in the same axial line.

In particular, the oil pump 50 may be a variable oil pump that changes the flow rate of oil on the basis of the engine output value and the fluid temperature that indicate the driving state of a vehicle.

The engine output value may be the engine RPM or the engine load (e.g. the use amount of fuel) and the fluid temperature may be a cooling water temperature or an oil temperature. The adjustment of flow rate of oil by the variable oil pump may be performed by a controller 100 and this controller 100 may be integrated with the controller that controls the motor RPM described above or may be a separate controller.

A method of controlling a hybrid oil pump system of the present invention largely includes measuring (S100) and controlling (S200).

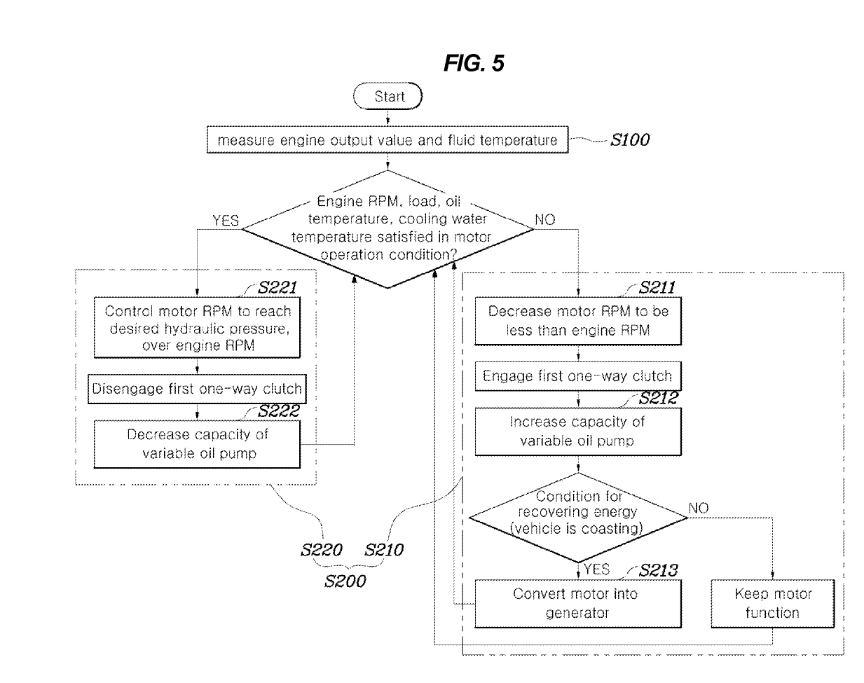

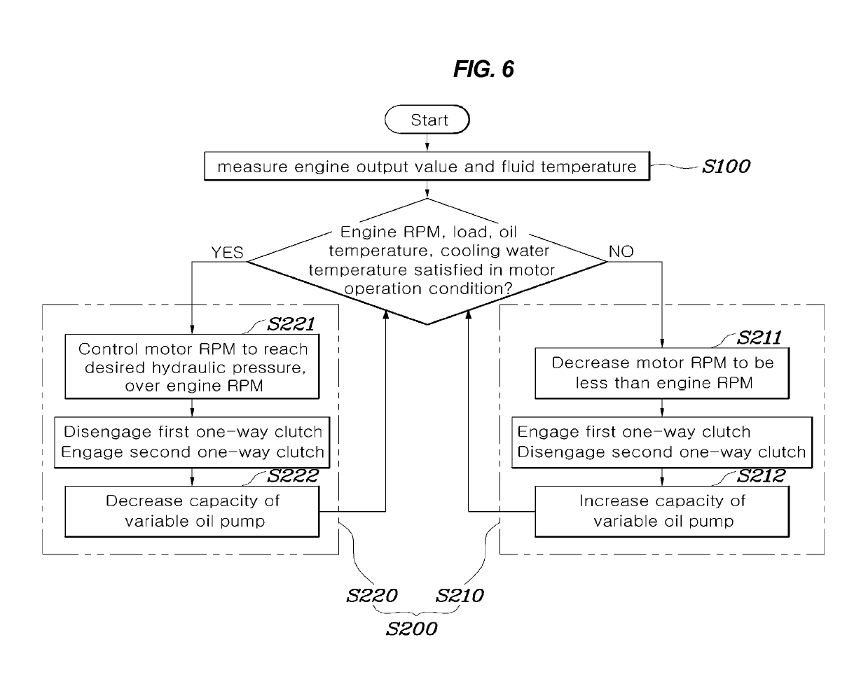

Referring to FIGS. 5 and 6, in the measuring (S100), an engine output value and a fluid temperature which indicate the driving state of a vehicle are first measured.

The engine output value may be may be an engine RPM or an engine load and the fluid temperature may be an oil temperature or a cooling water temperature.

In the controlling (S200), the RPM of the motor 10 is controlled in accordance with the engine output value and the fluid temperature so that the oil pump 40 is operated by the torque from the motor 10 or the torque from the engine 20 by engaging or disengaging the first one-way clutch 30, depending on the difference in RPM between the engine 20 and the motor 10.

The controlling (S200) can be applied in the same way to all of the oil pump systems equipped with the first one-way clutch 30 shown in FIGS. 1 to 4.

That is, when the fluid temperature and the engine output value are measured and it is determined that it is the operation period requiring the torque from the engine 20 on the basis of the measured fluid temperature and output value, the first one-way clutch 30 is engaged by adjusting the motor RPM to be smaller than the engine RPM. Accordingly, the oil pump 40 is operated by the torque from the engine 20.

When it is determined that it is the operation period not requiring torque from the engine 20, the first one-way clutch 30 is mechanically disengaged by adjusting the motor RPM to be larger than the engine RPM. Accordingly, the oil pump 40 is operated by the torque from the motor 10.

The controlling (S200) will be described in more detail with reference to FIGS. 5 and 6. The controlling (S200) includes engine operation controlling (S210) and motor operation controlling (S220).

In detail, a measurement value is obtained from the engine output value and the fluid temperature in the controlling (S200).

In particular, in the engine operation controlling (S210), when the measurement value is included in an engine operation standard value in a driving map showing the relationship between the engine output value and the fluid temperature, the motor RPM is adjusted to be less than the engine RPM (S211) so that the first one-way clutch 30 is engaged and the oil pump 40 is operated by the torque from the engine 20.

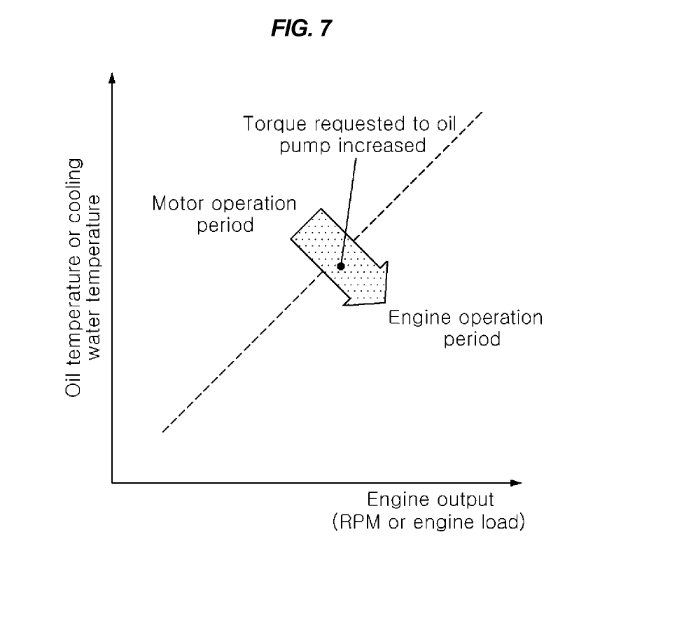

That is, as shown in FIG. 7, when the temperature of oil or cooling water is low, the viscosity of the oil is relatively large, so the effort for supplying oil increases. Further, hydraulic pressure and torque requested to the oil pump 40 are large for the operation period requiring large output from the engine 20, such that the load imposed on the oil pump 40 increases.

Accordingly, in this case, the RPM of the motor 10 is controlled to be lower than the engine RPM by decreasing the duty value for operating the motor 10, such that the torque from the engine 20 is supplied to the oil pump 40 through the first one-way clutch 30, thereby operating the oil pump 40.

Further, in the motor operation controlling (S220), when the measurement value is included in a motor operation standard value in the driving map, the motor RPM is adjusted over the engine RPM (S221) so that the first one-way clutch 30 is disengaged and the oil pump 40 is operated by the torque from the motor 10.

That is, as shown in FIG. 7, when the temperature of oil or cooling water is high, the viscosity of the oil is relatively small, so the effort for supplying oil decreases. Further, the requested hydraulic pressure is small for the operation period requiring small output from the engine 20, so the load on the oil pump 40 is small.

Accordingly, in this case, the RPM of the motor 10 is controlled to be higher than the engine RPM by controlling the duty ratio for operating the motor 10 to be relatively large, such that the oil pump 40 is operated by the torque from the motor 10, in which the toque from the engine 20 is disconnected by the first one-way clutch 30, so the engine torque is not transmitted to the oil pump 40.

Further, in the motor operation controlling (S220), the oil pressure generated by the oil pump 40 is measured and the RPM of the motor 10 may be adjusted so that the measured oil pressure follows a desired value.

The desired value may be a desired hydraulic pressure that can be compared with the measured hydraulic pressure and the desired hydraulic pressure may be a hydraulic pressure corresponding to the measurement value.

That is, the measured hydraulic pressure is fed-back to reach the desired hydraulic pressure corresponding to the measurement value, or the RPM of the motor 10 is increased or decreased so that the measured hydraulic pressure reaches a desire hydraulic pressure set through a specific control map.

In the engine operation controlling (S210) and the motor operation controlling (S220), the flow rate of oil determined by oil pump 40 may be variably controlled in accordance with the engine output value and the fluid temperature that indicate the driving state of a vehicle.

That is, in the engine operation controlling (S210), the requested hydraulic pressure and flow rate are large due to large engine output, so the load on the oil pump 40 is large. Accordingly, the flow rate for a predetermined driving condition is sufficiently obtained by controlling the capacity of the oil pump 40 to be relatively large (S212).

That is, in the motor operation controlling (S220), the requested hydraulic pressure and flow rate are small due to small engine output, so the load on the oil pump 40 is also small. However, as the RPM of the motor 10 increases, the flow rate of the oil and the hydraulic pressure unnecessarily increase, and accordingly, an appropriate flow rate for a predetermined driving condition is obtained by controlling the capacity of the oil pump 40 to be relatively small (S222).

Further, according to the method of the present invention, in the hybrid oil pump systems shown in FIGS. 1 and 2, when conditions under which energy can be recovered are satisfied, it is possible to generate power using the motor 10, in the engine operation controlling (S210).

For example, when the conditions under which energy can be recovered are satisfied, for example, when a vehicle coasts or a braking signal is inputted, it is possible to generate power by converting the motor 10 into a generator (S213).

The braking signal may be inputted to a controller and the controller can convert the motor into a generator.

According to an exemplary embodiment of the present invention, particularly for the hybrid oil pump system shown in FIG. 4, in the engine operation controlling (S210) shown in FIG. 6, it is possible to disengage the second one-way clutch 50 and prevent torque from being transmitted from the engine 20 to the motor 10, by controlling the engine RPM to be less than the engine RPM (S211).

That is, when the oil pump 40 is operated by the power from the engine, the second one-way clutch 50 relatively rotates and the power from the engine 20 is not transmitted to the motor 10, such that the power of the engine 20 is saved and fuel efficiency is improved.

Further, for the hybrid oil pump systems shown in FIGS. 3 and 4, in the motor operation controlling (S220) shown in FIG. 6, the motor RPM is controlled over the engine RPM (S221), such that the second one-way clutch 50 is engaged and the oil pump 40 is operated by the torque from the motor 10.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A hybrid oil pump system comprising:
a motor connected to an oil pump and supplying torque;
an engine disposed to supply torque to the oil pump; and
a first one-way clutch disposed in a line through which the torque from the engine is supplied to the oil pump, and selectively supplying the torque from the engine to the oil pump in accordance with a difference in RPM between the engine and the motor.

2. The system of claim 1, further comprising an engine driveshaft rotated by the torque from the engine,
wherein the first one-way clutch is connected to an end of the engine driveshaft.

3. The system of claim 2, wherein the first one-way clutch is engaged when an engine RPM is larger than a motor RPM, and is disengaged when the engine RPM is smaller than the motor RPM.

4. The system of claim 3, further comprising a controller operating the oil pump with the torque from the motor or the torque from the engine by engaging or disengaging the first one-way clutch in accordance with the difference in RPM between the engine and the motor by adjusting the motor RPM in accordance with an engine output value or a fluid temperature.

5. The system of claim 3, wherein the first one-way clutch is disposed between the motor and the engine.

6. The system of claim 5, wherein the motor, the first one-way clutch, and the engine are arranged in series from an end of the oil pump.

7. The system of claim 3, wherein the first one-way clutch is disposed between the oil pump and the engine.

8. The system of claim 7, wherein the motor is connected to a first end of the oil pump, and the first one-way clutch and the engine are connected to a second end of the oil pump.

9. The system of claim 3, wherein the motor is connected directly to the oil pump.

10. The system of claim 3, further comprising a second one-way clutch disposed between the motor and the oil pump and connecting/disconnecting the motor and the oil pump to/from each other in accordance with the difference in RPM between the motor and the oil pump.

11. The system of claim 10, wherein the second one-way clutch is engaged when a motor RPM is larger than an engine RPM, and is disengaged when the motor RPM is smaller than the engine RPM.

12. The system of claim 11, wherein the second one-way clutch, the motor, the first one-way clutch, and the engine are arranged in series from an end of the oil pump.

13. The system of claim 11, wherein the second one-way clutch and the motor are connected to a first end of the oil pump, and the first one-way clutch and the engine are connected to a second end of the oil pump.

14. The system of claim 3, further comprising a motor driveshaft rotated by the torque from the motor,
wherein the motor driveshaft and the engine driveshaft are arranged on the same axis.

15. The system of claim 1, wherein the oil pump is a variable oil pump changing a flow rate of oil in accordance with an engine output value and a fluid temperature that indicate a driving state of a vehicle.

16. A method of controlling the hybrid oil pump system of claim 1, the method comprising:
measuring an engine output value and a fluid temperature that indicate a driving state of a vehicle; and
controlling the oil pump to be operated by torque from the motor or torque from the engine by engaging or disengaging the first one-way clutch in accordance with the difference in RPM between the engine and the motor by adjusting a motor RPM in accordance with the engine output value and the fluid temperature.

17. The method of claim 16, wherein the engine output value is an engine RPM or an engine load, and
the fluid temperature is an oil temperature or a cooling water temperature.

18. The method of claim 16, wherein the controlling includes:
engine operation controlling that obtains a measurement value on the basis of the engine output value and the fluid temperature and adjusts the motor RPM to be less than an engine RPM so that the first one-way clutch is engaged and the oil pump is operated by the torque from the engine, when the measurement value is included in an engine operation standard value in a driving map showing a relationship between the engine output value and the fluid temperature; and
motor operation controlling that adjusts the motor RPM over the engine RPM so that the first one-way clutch is disengaged and the oil pump is operated by the torque from the motor, when the measurement value is included in a motor operation standard value in the driving map.

19. The method of claim 18, wherein in the motor operation controlling, oil pressure generated by the oil pump is measured and the motor RPM is adjusted so that the measured oil pressure follows a desired value.

20. The method of claim 18, wherein the oil pump is a variable pump and, in the engine operation controlling and the motor operation controlling, the oil pump is controlled to change a flow rate of oil determined by the oil pump in accordance with an engine output value and a fluid temperature that indicate a driving state of a vehicle.

21. The method of claim 18, wherein in the engine operation controlling, when conditions under which energy is recovered are satisfied, power is generated by the motor.

22. The method of claim 18, wherein a second one-way clutch is further disposed between the motor and the oil pump of the system,
the second one-way clutch is disengaged and the torque from the engine is transmitted to the motor by adjusting the motor RPM to be less than the engine RPM, in the engine operation controlling, and
the second one-way clutch is engaged and the oil pump is operated by the torque from the motor by controlling the motor RPM over the engine RPM, in the motor operation controlling.
